(19) United States
(12) Patent Application Publication
(10) Pub. No.: US 2007/0083589 A1
(43) Pub. Date: Apr. 12, 2007

(54) Method and apparatus for multi-user generation of domain specific knowledge and adjunct interface

(76) Inventor: Luke Matthew Olsen, Portland, OR (US)

Correspondence Address: Luke M. Olsen, 9860 SW 29th Place, Portland, OR, 97219, US

(21) Appl. No.: 11/234,737

(22) Filed: Sep. 26, 2005

(51) Int. Cl. G06F 15/16

(52) U.S. Cl. 709/203

(57) ABSTRACT

A method for providing interactive, multi-user, self-managing, user-generated documentation for a software application accessible from multiple workstations comprising: running the software application that may be installed on the workstation, a network, or the Internet; invoking an adjunct interface for providing a user-to-user question and answer session associated with the software application; generating a FAQ based on the user-to-user question and answer session; saving the FAQ in a database that is user searchable; and linking the database to the software application.

### BACKGROUND

As we rely more and more on computers and computer software at our place of work and even in our homes, the necessity to retain network, system, and application knowledge increases on a regular basis. The computer network that has been developed at the workplace typically require employees to learn simple to more complex procedures such as selecting a printer, changing a password, remote login, or connecting to a network directory. As networks and operating systems are updated or replaced, this often means that the employees will need to relearn existing procedures or be introduced to new procedures. Similarly, computer applications are updated and replaced as new operating systems are released or as companies decide to use a different platform. In some cases, software bugs are corrected by sending a new software update, however associated help files may not be correspondingly updated. All of these changes require the employee to retain a certain amount of expertise and spend a significant amount of time to learn new procedures. These activities are not value added, and in turn require additional assistance from computer support and help desks.

Compounding the above is the increasing trend for employees to move from one company to another multiple times throughout their careers, whereby information is often lost that may have been in the heads of past employees, written on sticky notes attached to a computer screen, or included on a file that resided on an employee's work station. Even if this information is ultimately retrievable, the lost time due to employees having to learn or discover the information can be significant.

Some software and operating system suppliers have attempted to address these problems by providing software that monitors the computer user's actions and attempts to provide on-time help information to guide the user through the software, system, or network procedure. Still other software manufactures have developed help documentation files that may be accessed and modified directly by the user of the program, thereby providing some level of customization. In either of these cases, the user must rely on the supplier to provide such a tool to interact with the application. Information is still integrally linked to the application and may therefore be lost when applications are updated or replaced. Information created by a user is either retained locally to the user, and therefore is not accessible by other users in the company, or may be retained on a central server or network, in which case the information is liable to grow to an unmanageable level or require frequent supervision by a system manager.

It is therefore an objective of this invention to provide an interactive, multi-user, self-managing, user-generated documentation system that exists and is created independently from one or more applications, but that can be associated with an application by an external program. The goal of this invention is not to replace existing user documentation provided by the application supplier, but to provide a context specific repository of user specific application knowledge which other users can access within that context. The present invention addresses these and other problems associated with the prior art.

### SUMMARY OF THE INVENTION

A computerized system for creating interactive, multi-user, self-managing, user-generated documentation accessible from multiple workstations comprising: a software application that may be installed on the workstation, a network, or the Internet; an adjunct interface for providing a user-to-user question and answer session associated with the software application; a FAQ that is automatically generated from the user-to-user question and answer session; a database that includes the FAQ and user generated questions and answers, wherein the FAQ is associated with the software application; and a watcher program that monitors what software application is opened and invokes the associated adjunct interface, wherein the adjunct interface provides the additional means of searching the database.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a pictorial diagram showing a top-level system configuration.

FIG. 2 is a block diagram depicting the primary functions of the system.

FIG. 3 is a block diagram providing alternate means of invoking an adjunct interface.

FIG. 4 is a pictorial diagram showing an example of an adjunct interface.

FIG. 5 is a flow chart showing a typical logic flow for user query and FAQ generation.

### DETAILED DESCRIPTION

In the embodiments described herein, the system is comprised of software divided into two categories of server software and client software, specifically that which resides on one or more servers, and that which resides on one or more user workstations, respectively. In some circumstances, the server and workstation may be one and the same, however the preferred embodiment would suggest a central server that communicates with numerous local and/or remote client workstations via standard TCP/IP protocols used by the Internet and by corporate Intranets. The system is inherently multi-user based, and requires a storage device for captured knowledge.

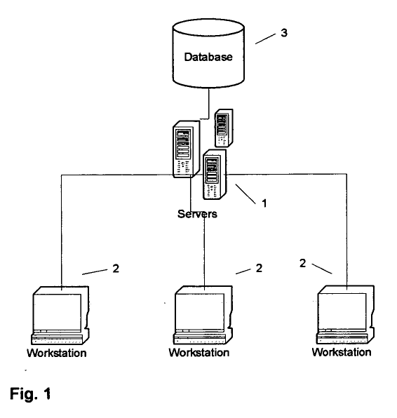

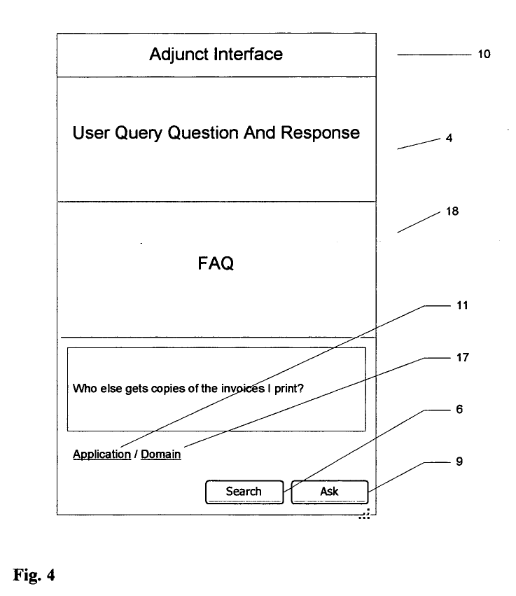

FIG. 1 provides a typical system configuration with the server 1 or servers functioning to provide workstations 2 access to the storage device, or database 3. The software provided for the server 1 includes executable code which manages the communication between the server 1 and the clients, and manages the relationship between the executable code and the database 3. Software provided for the workstations 2 includes an adjunct interface 10, see FIG. 4, that allows users to query other users, query the database 3, and respond to other user queries.

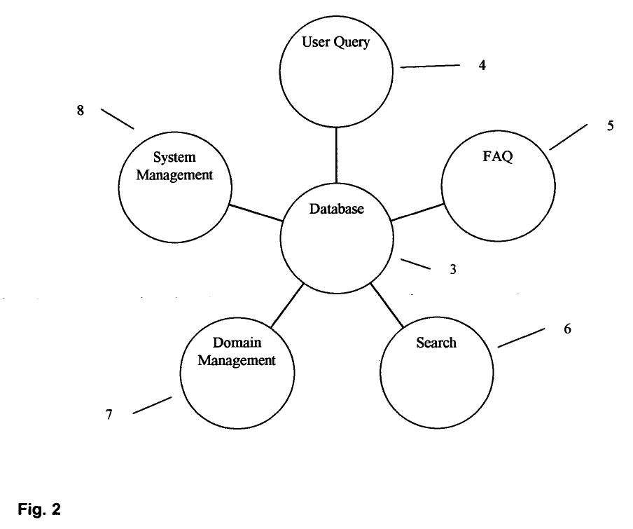

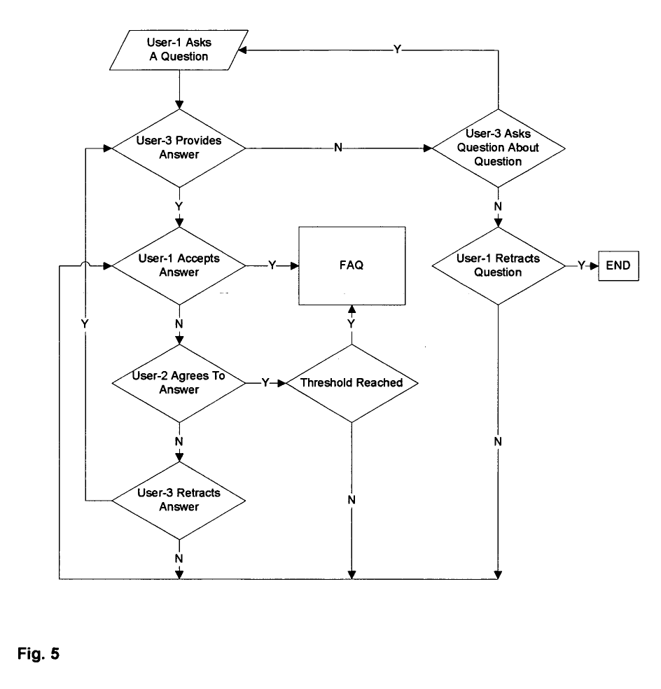

FIG. 2 shows one embodiment of the system having numerous functions associated with data management and user queries. The central hub of FIG. 2 is the database 3 which stores the system data and data relationships. Other than system management, these functions are all initiated via the adjunct interface 10, whereby the user is able to send queries and manage the data within the system as regulated by the server software and client software. A user query 4 provides for user-to-user question and answer sessions, whereby users may ask questions of a user or user group, and other users may respond by providing an answer to the question. The query 4 is an interactive process by which multiple users may be engaged to help document a procedure in order to provide useful information to other users who may have the need to perform the same or similar function. The query 4 is more fully defined in the flowchart shown in FIG. 5 which provides the relationship between the query and the data that is stored in the database 3.

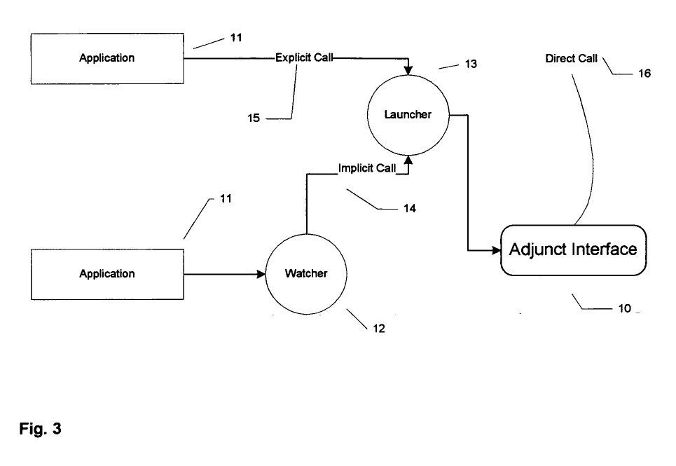

FAQ generation 5 is a function by which the questions and answers are created during the query 4 function. A FAQ 18 (Frequently Asked Questions) is a common acronym in the computer and software industry that is often provided with software user documentation to help answer questions which users may typically ask while in the process of learning to user a software application 11, see FIG. 3, or when trying to learn more advanced features of the application 11. The FAQ 18 in a typical user documentation is a static list of information that does not change or grow because it is controlled by the software supplier or maintainer. This system generates the FAQ 18 independently of the application 11, as a result of the query 4 that is initiated by a user, and managed primarily by the interaction between other users. The FAQ 18 created during FAQ generation 5 may pertain to a specific domain 17, see FIG. 4, within the application 11, to the application 11 itself, or to multiple applications. The FAQ 18 is searchable and sortable, and may be associated with the domain 17 or the application 11. FAQ generation 5 is more fully defined in the flowchart shown in FIG. 5.

Search 6 is a function which allows users to examine the database 3 and review the FAQ 18. A user may be limited in their ability to fully utilize the search 6 function according to the domain 17 which the user is registered to, or to the application 11 or applications which the user is registered to. The search 6 can be limited in scope to the domain 17, to the application 11, or to multiple applications. The scope of the search 6 can be determined by the user requesting the search 6.

Domain management 7 is a functional application whereby one or more domain experts manage the FAQ 18 and other data associated with their area or areas of responsibility. Domain experts are a subset of users who have privileged access and control rights with regards to data management. The domain 17 can include a functional area of a company such as engineering or accounting, or can be identifiable by a region such as the US and Europe, or can be a combination of both, for example. The domain experts can edit, add to, or delete the FAQ 18 that has been generated by a query 4, in an effort to regulate or keep updated the information that is available during a search 6. Although the user documentation is user-generated and self-managing, the data that is stored in the database 3 can, overtime, become obsolete for example. Similarly, as company policies are revised or changed, the FAQ 18 that resides in the system may no longer be applicable, and must be reviewed occasionally by a domain expert. Domain management 7 may further comprise the capability of the domain expert to maintain a list of users authorized to search the FAQ 18 or respond to questions that are associated with the domain 17. In addition, the domain expert is able to broadcast domain alerts to all users associated with the domain 17, for example when the FAQ 18 is particularly relevant to all users.

System management 8 is the responsibility of a network or system manager who has ultimate responsibility to ensure that the system is functioning correctly. Responsibilities include managing which users are classified as domain experts, managing which domains and applications users have access to, adding and deleting users, sending out system alerts, setting up and managing other system options, and typically managing all functions that the domain expert is capable of doing, as required..

The application 11 that is installed on the server 1, workstations 2, or the Internet, and that is accessible by multiple users, may be identified by multiple domains. For example, a business management software program may have procedures and responsibilities associated with specific functional domains such as finance, human resources, and operations. The FAQ 18 that is generated by each of these domains may not be relevant to the other sections, and therefore it is useful that the FAQ 18 may be separated by each domain 17. System management 8, therefore, would determine how many and which domains would be associated with a particular software application 11. As a result, there may be multiple sets the FAQ 18 that are associated with the application 11. Alternatively, one FAQ 18 could be associated with multiple applications. Domain management 7 would typically determine which users require access to their domain 17, according to the specific application 11 in question. User access to a domain 17 specific FAQ 18 can be controlled by a list of authorized users and according to the: user identification, for example. The appropriate FAQ 18 would be available according to the application 11 that is opened and according to the user identification and authorization. Some applications may have only one domain 17 defined, for example if the application 11 is only used by finance, or if all users require access to the application 11, for example, which is an overtime sheet.

The adjunct interface 10 may be invoked by any or three different methods as depicted in FIG. 3. In the preferred embodiment, the adjunct interface 10 would be invoked by an implicit call 14 automatically any time that an application 11 is opened, and provided the user has authority to view the FAQ 18 associated with the application 11. The FAQ 18 that would be displayed to the user in the adjunct interface 10 would depend on what application 11 was opened, and what domain 17 the user is registered under, or has authorization for. A watcher 12 is software that is installed on a workstation 2 and that is programmed to monitor any applications that are opened and viewable on the workstation 2. When an application 11 is recognized by the watcher 12 as being associated with the FAQ 18, the watcher 12 will make an implicit call to a launcher 13. The launcher 13 is software that is installed on a workstation and that executes the adjunct interface 10. The adjunct interface 10, or browser, is of the same basic format as a browser that is commonly used to search and view information on the Internet, for example, however software could easily be developed that would replace the browser technology and serve the same function. The exact format of the adjunct interface 10, may be programmed in may different views, one example of which is shown as FIG. 4. This invention contemplates browser and non-browser technology being used to generate the adjunct interface 10 which may in of itself take on many different forms and functions.

By using an implicit call 14, the invocation of the adjunct interface 10, and the content therein, is not dependent on or controlled by any executable code as found in the application 11, or as supplied by the supplier of the-application 11. The FAQ 18 and other data that are created in this system are maintained and stored independently of the application 11, such that subsequent installations of the application 11 or upgrades thereto, will not result in the unintentional deletion of this data. The FAQ 18 and other data can be updated, deleted, or added to according to the specific needs and procedures of the company which is using the application 11.

An explicit call 15 may also be utilized by the system, whereby the application 11 itself includes executable code which would instruct the launcher 13 to invoke the adjunct interface 10. The explicit call 15 does not require the presence of a watcher 12, since the explicit call 15 is made by the application 11 itself. While this method provides for the greatest possible control over domain management 7 and adjunct interface 10 invocation, it also requires that the application 11 developer incorporates the explicit call in the application 11 when it is being developed. In any event, the system maintains the benefit of having the user documentation and database 3 stored independently from the application 11, and the content of the database 3 continues to be controlled by the user-generated, self-managing system described in this invention.

The third method by which to invoke the adjunct interface 10 is for the user to make a direct call 16. In the direct call 16, the user is able to manually open the adjunct interface 10, and select the application 11 and domain 17 related to the FAQ 18 for which the user wants to conduct the search 6. The direct call 16 does not require that the application 11 be installed on the user's workstation 2, or even that the user has access to the application 11. Multiple sessions of the adjunct interface 10 may be opened at any one time, under any of these means of invocation, thereby allowing the user to view the FAQ 18 for multiple applications, or for multiple domains within the same application, or any combination thereof.

FIG. 4 provides an example of the adjunct interface 10 which can be used with this system. In the example shown, there are three sections that are viewable. The top section shows a question and answer dialogue between one or more users, and this section will be populated only if there is a question that has not yet been answered and approved. The middle section shows the FAQ 18, or a portion thereof, that have been generated for the application 11 and domain 17. The application 11 and domain 17 may be determined automatically, for example when an implicit call 14 or explicit call 15 has been made, or the application 11 and domain 17 may be user selectable according to the search 6 made under a direct call 16. The application 11 and domain 17 are shown in the bottom section of the adjunct interface 10, next to the search 6 and ask 9 functions. The search 6 function is as described previously, whereby the user is able to search the database for the existing FAQ 18 according to the selected application 11 and domain 17. The ask 9 function is the means by which the user submits a question into the system. The user is able to select which domain 17 within the application 11 is to be associated with the question, or the user may select all domains within the application 11. The FAQ 18 may be sorted explicitly by the domain expert, or may be sorted automatically by the query 4 function, for example in order of approval. A long FAQ 18 may be handled by pagination commands that allow the user to navigate in set blocks of FAQ 18 entries.

When the user begins a query 4, the system assigns an application 11 and domain 17 to the query 4 according to the application 11 that is opened or has been explicitly selected by the user, and according to the domain 17 associated with the user id or that has been explicitly selected by the user. According to the number of domains associated with the application 11 or according to the user selection, the query 4 may be associated with all domains within the application 11, or even for multiple applications. The query 4 is initiated when a user enters a question into the system by selecting the ask 9 function. Only those users who have been authorized with the application 11 and domain 17 associated with the question are able to respond to and view the question. In one embodiment of the invention, unauthorized users may be able to view the questions, but would not be able to respond to them. For example, a billing question may be directed to those users associated with a billing, or finance, domain, whereas a shipping question may be directed to users associated with a shipping domain. Both of these questions could be associated with the same application 11.

FIG. 5 depicts a typical flow chart which can be used to manage the query 4 and FAQ generation 5 for this system. In this flowchart example, user-1 is identified as being the primary control user who asks an initial question in the query 4 function, and who is able to accept an answer and thereby create a FAQ 18. User-2 is identified as being a secondary user, or the user who is able to agree to an answer and thereby create a FAQ 18. User-3 is identified as being a third user who answers a question posed by user-1, but by which no FAQ 18 is thereby created.

After user-1 asks a question, the question is submitted to the system. All users associated with the application 11 and domain 17 will be able to view the question. If user-3 does not answer the question, but instead makes a comment or asks a related question, than the system will update the original user-1 question with the comment or question. If the user-3 does not answer the question and does not make any comment or related question, then the user-1 is able to retract the question, and thus close the query 4 session, or the system waits for a user-3 response. If the user-3 answers the question, than user-1 is able to accept the answer and a FAQ 18 is created. Alternatively a user-2 may nevertheless agree to the answer given by user-3 providing that user-2 is not the same user as user-3. Furthermore, a user-2's agreement to the answer by user-3 will be turned into a FAQ 18 if either a system-specified length of time after the last agreement to user-3's answer is reached, or a minimum number of agreements is reached by a number of user-2s. If the length of time is set to zero and the number of agreements is set to 1 then any user-2's agreement to user-3's answer will create a FAQ 18. Alternatively, an embodiment of the invention is conceived whereby a disagreement between one or more users could be decided by the domain manager, or by a rating system wherein multiple users score the accuracy of the response and the system will determine if a FAQ 18 should be created.

If neither the user-1 nor the user-2 accept or agree to the answer, respectively, than the user-3 is able to retract the answer. If the answer is retracted, then the system waits for a response from user-3 as if the question was newly asked by user-1. If the user-3 does not retract the answer, then the system waits until user-1 accepts or until user-2 agrees. Multiple instances of the query 4 may be instigated for the same question, whereby two or more user-3 may provide an answer to the question. User-1 and user-2 are able to accept or agree, respectively, to each of the questions independently. If any of the answers are accepted then a FAQ 18 is generated and the query 4 function comes to an end. Furthermore if any of the questions are agreed upon and the minimum thresholds, as described above, are exceeded than a FAQ 18 is generated and the query 4 function comes to an end. Although the system is intended to be self-managing, whereby the FAQ 18 is created through the interactive, user-generated questions and answers, a certain amount of data management by the domain expert will likely be required. The amount of interaction by the domain expert will also be dependent on the desired level of dispute resolution between multiple users where collective answers may not be compatible, for example.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. I claim all modifications and variation coming within the spirit and scope of the following claims.

I claim:

1. A method for providing interactive, multi-user, self-managing, user-generated documentation for a software application accessible from multiple workstations comprising:
running the software application that may be installed on the workstation, a network, or the Internet;
invoking an adjunct interface for providing a user-to-user question and answer session associated with the software application;
generating a FAQ based on the user-to-user question and answer session;
saving the FAQ in a database that is user searchable; and
linking the database to the software application.

2. The method according to claim 1 including explicitly invoking the adjunct interface by means of a call from an executable code within the software application.

3. The method according to claim 1 including implicitly invoking the adjunct interface by means of watcher program that resides on the workstation and monitors the associated software application that is running.

4. The method according to claim 1 including directly invoking the adjunct interface regardless of the software application that is running.

5. The method according to claim 1 including generating a FAQ that is associated to a domain with one or more users, and generating other FAQ that are associated with one or more other domains.

6. The method according to claim 5 including managing the FAQ associated with each domain, and managing the users who are associated with each domain.

7. The method according to claim 1 wherein the adjunct interface includes a means of searching the database for the FAQ.

8. The method according to claim 1 wherein the adjunct interface includes a means for submitting a question to one or more domains.

9. The method according to claim 1 wherein the user-to-user question and answer session includes a means for accepting or agreeing with an answer and thereby creating a FAQ.

10. The method according to claim 1 including providing a rating system whereby users are able to assign a rating to an answer or answers in order to determine if a FAQ should be created.

11. An apparatus for providing interactive, multi-user, self-managing, user-generated documentation accessible from multiple workstations comprising:
a software application that may be installed on the workstation, a network, or the Internet;
an adjunct interface for providing a user-to-user question and answer session associated with the software application;
a FAQ that is generated from the user-to-user question and answer session; and
a database that includes the FAQ and user generated questions and answers, wherein the FAQ is associated with the software application.

12. The apparatus according to claim 11 including executable code within the software application that explicitly invokes the adjunct interface.

13. The apparatus according to claim 11 including a watcher program that is installed on the workstation, wherein the watcher monitors the software application that is opened and implicitly invokes the adjunct interface that is associated with the software application.

14. The apparatus according to claim 11 including a means for a user to directly invoke the adjunct interface regardless of the software application that is opened.

15. The apparatus according to claim 11 wherein the FAQ is associated with one or more domains, and each domain is associated with one or more users.

16. The apparatus of claim 11 wherein the adjunct interface includes a means for searching the database.

17. The apparatus according to claim 11 wherein a user is able to send a question to one or more domains.

18. The apparatus according to claim 11 wherein the user-to-user question and answer session includes a means for accepting or agreeing with an answer and thereby creating a FAQ.

19. The apparatus according to claim 11 including a domain expert who manages the FAQ associated with a domain, and manages the users associated with the domain.

20. A computerized system for creating interactive, multi-user, self-managing, user-generated documentation accessible from multiple workstations comprising:
a software application that may be installed on the workstation, a network, or the Internet;
an adjunct interface for providing a user-to-user question and answer session associated with the software application;
a FAQ that is automatically generated from the user-to-user question and answer session;
a database that includes the FAQ and user generated questions and answers, wherein the FAQ is associated with the software application; and
a watcher program that monitors what software application is opened and invokes the associated adjunct interface, wherein the adjunct interface provides the additional means of searching the database.
